(19) United States
(12) Patent Application Publication
(10) Pub. No.: US 2020/0210041 A1
(43) Pub. Date: Jul. 2, 2020

(54) TOUCH DISPLAY PANEL AND BONDING METHOD THEREOF

(71) Applicant: WUHAN CHINA STAR OPTOELECTRONICS SEMICONDUCTOR DISPLAY TECHNOLOGY CO., LTD., Wuhan, Hubei (CN)

(72) Inventor: Minlun LIU, Wuhan, Hubei (CN)

(21) Appl. No.: 16/609,220

(22) PCT Filed: Nov. 20, 2018
(86) PCT No.: PCT/CN2018/116346

§ 371 Date: Oct. 29, 2019

(30) Foreign Application Priority Data
Oct. 8, 2018 (CN) 201811168693.X

(51) Int. Cl. G06F 3/041

(52) U.S. Cl. CPC G06F 3/04164; G06F 3/044

(57) ABSTRACT

The present invention provides a touch display panel and a bonding method of the touch display panel, including a display panel, the display panel being provided with a bonding region, the bonding region including electrically conductive connection regions disposed separately and an electrically insulative connection region; a touch layer positioned on the display panel, the touch layer including a sensing electrode and a signal lead, the signal lead being extended to the electrically conductive connection region; and a flexible printed circuit board including a first pad, the first pad including a first connection sub-pad and a first dummy sub-pad, the first connection sub-pad being electrically connected to the signal lead.

### 1. FIELD OF DISCLOSURE

The present invention relates to a field of display devices and, in particular, to a touch display panel and a bonding method thereof.

### 2. DESCRIPTION OF RELATED ART

Touch control is currently the most simple and convenient way of human-computer interaction, so touch screens are increasingly used in various electronic products. Capacitive touch screens include surface capacitive touch screens, projective capacitive touch screens, and projective capacitive touch screens can be divided into self-capacitance type and mutual capacitance type touch screens. Due to full screen trends, a bezel of a touch display screen has to be narrower and narrower. However, production yield and design requirement have to be considered, so developing ultra-narrow bezel or bezel-free touch display screens has always been a big challenge.

Therefore, conventional techniques have drawbacks and are in urgent need of improvement.

### SUMMARY

The present invention provides a touch display panel and a bonding method, which can realize a narrow bezel design of the touch display panel, can bond a flexible printed circuit board at one time with pads arranged as multiple segments, and improve reliability of the touch display panel.

In order to solve the above problems, a technical solution provided by the present application is as follows.

The present provides a touch display panel, comprising:

a display panel, the display panel being provided with a bonding region disposed corresponding to a non-display region, the bonding region comprising at least two electrically conductive connection regions disposed separately and an electrically insulative connection region disposed between each adjacent two of the at least two electrically conductive connection regions;

a touch layer disposed on the display panel, the touch layer comprising a plurality of sensing electrodes and a plurality of signal leads electrically connected to the sensing electrodes respectively, another end of each signal lead being extended to a corresponding one of the electrically conductive connection regions; and

a flexible printed circuit board comprising a first pad disposed corresponding to the bonding region, the first pad being used to bond the bonding region and the display panel;

wherein the first pad comprises a plurality of first connection sub-pads each disposed corresponding to each electrically conductive connection region and a plurality of first dummy sub-pads each disposed corresponding to each electrically insulative connection region, the first connection sub-pads are used for being electrically connected to the signal leads, and the first connection sub-pads and the first dummy sub-pads are integrally formed.

In the touch display panel of the present invention, a portion of at least one of the signal leads disposed in each electrically conductive connection region forms a second connection sub-pad, the display panel is provided with a second dummy sub-pad in each electrically insulative connection region, and the second dummy sub-pads and the second connection sub-pads form a second pad.

In the display panel of the present invention, an adhesive layer is disposed between the first pad and the second pad, and the adhesive layer bonds the flexible printed circuit board to the display panel.

In the touch display panel of the present invention, each first connection sub-pad is disposed corresponding to and electrically connected to each second connection sub-pad, and each first dummy sub-pad is disposed corresponding to each second dummy sub-pad and electrically insulated from the same.

In the touch display panel of the present invention, the flexible printed circuit board sequentially comprises a bending region and a non-bending region at one side of the first pad, and a portion of the bending region of the flexible printed circuit board is bent to make the non-bending region moved to a back-side of the display panel.

In the touch display panel of the present invention, the flexible printed circuit board is provided with a plurality of hollow portions spaced from each other in the bending region.

In the touch display panel of the present invention, the hollow portions are arranged in a direction the same as a direction in which the first dummy sub-pads are arranged, and each of the hollow portions is positioned corresponding to each of the first dummy sub-pads.

In the touch display panel of the present invention, a boundary of each of the hollow portions is extended to a boundary of the first pad.

The present invention provides a bonding method of the touch display panel mentioned above, comprising following steps:

S10: coating an adhesive on the bonding region of the display panel;

S20: attaching one end of the flexible printed circuit board, which is provided with the first pad, to the adhesive on the bonding region;

S30: bonding the flexible printed circuit board to the display panel by performing a hot pressing process one time using a hot pressing device, wherein one of the first connection sub-pads is electrically connected to the signal lead of a corresponding one of the electrically conductive connection regions.

In order to solve the above problems, a technical solution provided by the present invention is as follows.

The present invention provides a touch display panel, comprising:

a display panel, the display panel being provided with a bonding region disposed corresponding to a non-display region, the bonding region comprising at least two conductive connection regions disposed separately and an electrically insulative connection region disposed between each adjacent two of the electrically conductive connection regions;

a touch layer disposed on the display panel, the touch layer comprising a plurality of sensing electrodes and a plurality of signal leads electrically connected to the sensing electrodes respectively, another end of each signal lead being extended to a corresponding one of the electrically conductive connection regions; and

a flexible printed circuit board comprising a first pad disposed corresponding to the bonding region, the first pad being used for bonding the bonding region and the display panel;

wherein the first pad comprises a plurality of first connection sub-pads each disposed corresponding to each electrically conductive connection region and a plurality of first dummy sub-pads each disposed corresponding to each electrically insulative connection region, and the first connection sub-pads are used for being electrically connected to the signal leads.

In the touch display panel of the present invention, a portion of at least one of the signal leads disposed in each electrically conductive connection region forms a second connection sub-pad, the display panel is provided with a second dummy sub-pad in each electrically insulative connection region, and the second dummy sub-pads and the second connection sub-pads form a second pad.

In the touch display panel of the present invention, an adhesive layer is disposed between the first pad and the second pad, and the adhesive layer bonds the flexible printed circuit board to the display panel.

In the touch display panel of the present invention, each first connection sub-pad is disposed corresponding to and electrically connected to each second connection sub-pad, and each first dummy sub-pad is disposed corresponding to each second dummy sub-pad and electrically insulated from the same.

In the touch display panel of the present invention, the flexible printed circuit board sequentially comprises a bending region and a non-bending region at one side of the first pad, a portion of the bending region of the flexible printed circuit board is bent to make the non-bending region move to a back-side of the display panel.

In the touch display panel of the present invention, the flexible printed circuit board is provided with a plurality of hollow portions spaced from each other in the bending region.

In the touch display panel of the present invention, the hollow portions are arranged in a direction the same as a direction in which the first dummy sub-pads are arranged, and each of the hollow portions is positioned corresponding to each of the first dummy sub-pads.

In the touch display panel of the present invention, a boundary of each of the hollow portions is extended to a boundary of the first pad.

Compared with conventional touch display panels, the advantages of the present application are as follows. In the touch display panel and the bonding method thereof provided by the present application, the dummy sub-pads have no electrical characteristics and are distributed evenly to vacant spaces between connection sub-pads which are arranged separately as multiple segments, the pads adopt a full coverage design which cover the bonding region, and thereby in the bonding process, expansion coefficients are stable, a bonding environment is stable, and the connection sub-pads positioned in multiple areas can be bonded at one time, which greatly reduces processing time and costs. At the same time, it is beneficial to realize a narrow bezel design of the touch display panel and is advantageous to increase adhesion of the pad and improve its reliability. In addition, the hollow portions are positioned in the bending region of the flexible printed circuit board, so stress in the bending region is reduced, thus greatly enhancing reliability of the manufacturing process.

### BRIEF DESCRIPTION OF DRAWINGS

In order to more clearly illustrate the embodiments of the present disclosure or related art, figures which will be described in the embodiments are briefly introduced hereinafter. It is obvious that the drawings are merely for the purposes of illustrating some embodiments of the present disclosure, a person having ordinary skill in this field can obtain other figures according to these figures without an inventive work or paying the premise.

FIGS. 1A and 1B are schematic structural views illustrating a touch display panel according to one embodiment of the present invention; and

FIG. 2 is a schematic view illustrating a process flow of a bonding method of the touch display panel according to one embodiment of the present invention.

### DETAILED DESCRIPTION OF EMBODIMENTS

Embodiments of the present disclosure are described in detail with reference to the accompanying drawings as follows. Directional terms such as up/down, right/left and the like may be used for the purpose of enhancing a reader's understanding about the accompanying drawings, but are not intended to be limiting. Specifically, the terminologies in the embodiments of the present disclosure are merely for the purpose of describing certain embodiments, but not intended to limit the scope of the invention. The same reference numbers are used throughout the drawings to refer to the same or similar parts.

The present application aims to solve problems existing in conventional touch display panels. The conventional flexible printed circuit board, which has pads disposed separately, requires a long bonding process time and has low reliability, which is disadvantageous for implementing a narrow bezel design of the touch display panel. The present invention can solve the drawbacks.

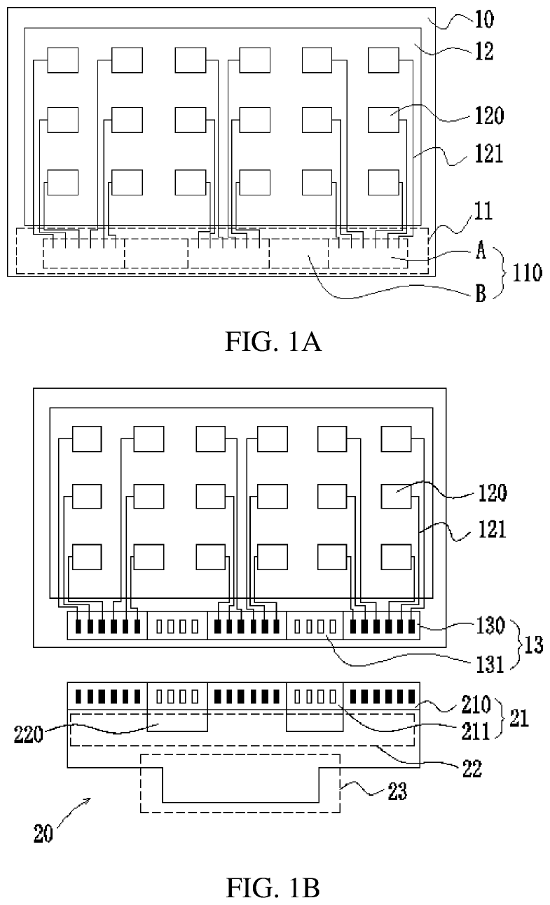

Please refer to FIGS. 1A and 1B which are schematic structural views showing a touch display panel before bonded according to one embodiment of the present invention. The touch display panel comprises:

a display panel 10, the display panel 10 being provided with a bonding region 110 disposed corresponding to a non-display region 11, the bonding region 110 comprising at least two electrically conductive connection regions A disposed separately as multiple segments and an electrically insulative connection region B disposed between each adjacent two of the at least two electrically conductive connection regions A; and

a touch layer 12 disposed on the display panel 10, the touch layer 12 comprising a plurality of sensing electrodes 120 and a plurality of signal leads 121 electrically connected to the sensing electrodes 120 respectively, another end of each signal lead 121 being extended to a corresponding one of the electrically conductive connection regions A.

The touch layer 12 may be of a self-capacitance type or a mutual capacitance type; the present invention is not limited in this regard. The touch layer 12 is a self-capacitance-type touch layer as an example for illustration.

It is preferable that, each signal lead 121 connected to each sensing electrode 120 is extended to a closet corresponding one of the electrically conductive connection regions A. The signal leads 121 are evenly distributed in different electrically conductive connection regions A.

Please refer to FIG. 1B. A flexible printed circuit board 20 comprises a first pad 21 disposed corresponding to the bonding region 110. The first pad 21 is used to bond the bonding region 110 and the display panel 10. The first pad 21 comprises a plurality of first connection sub-pads 210 disposed separately corresponding to the electrically conductive connection regions A respectively and a plurality of first dummy sub-pads 211, each disposed corresponding to each electrically insulative connection region B, and the first connection sub-pads 210 are used for being electrically connected to the signal leads 121. The first dummy sub-pads 211 do not have electrical characteristics and are electrically insulative.

Preferably, the first connection sub-pads 210 and the first dummy sub-pads 211 are integrally formed, and each connection sub-pad 210 and each dummy sub-pad 211 are of a same size and thickness.

A second pad 13 is formed in the bonding region 110 of the display panel 10. A portion of at least one of the signal leads 121 disposed in each electrically conductive connection region A forms a second connection sub-pad 130, the display panel 10 is provided with a second dummy sub-pad 131 in each electrically insulative connection region B. The second connection sub-pads 130 are distributed in a manner consistent with a manner in which the first connection sub-pads 210 are distributed. The second dummy sub-pads 131 are distributed in a manner consistent with a manner in which the first dummy sub-pads 211 are distributed, and the second dummy sub-pads 131 and the first dummy sub-pads 211 have no electrical characteristics.

The second pad 13 completely covers the bonding region 110, and the first pad 21 is disposed corresponding to the bonding region 110, and therefore, by providing an adhesive layer (not illustrated) on the second pad 13, the adhesive layer bonds the flexible printed circuit board 20 to the display panel 10. Each first connection sub-pad 210 and each second connection sub-pads 130 are disposed corresponding to each other and electrically connected to each other, and each first dummy sub-pad 211 and each second dummy sub-pad 131 are disposed corresponding to each other and electrically insulated from each other.

The first connection sub-pads 210 of the flexible printed circuit board 20 are arranged as three segments, and may be arranged as multiple segments, such as two segments or more, in alternative embodiments; and the present invention is not limited in this regard.

In a narrow bezel design of a conventional touch display panel, there is a method which includes a flexible printed circuit board having pads arranged as multiple segments divided by openings, but expansion coefficients in bonding cannot be compensated due to a hollow opening in the middle. If one-time hot pressing is carried out, deformation at both sides of the pad is large, but if the bonding is performed by using hot pressing for multiple times, it takes a long time.

In the present embodiment, the dummy sub-pads with no electrical characteristics are evenly distributed in vacant spaces between the connection sub-pads which are arranged as multiple segments, the pad has a full coverage design which covers the bonding region, and thereby in the bonding process, expansion coefficients are stable, a bonding environment is stable, and the connection sub-pads arranged in multiple areas can be bonded at one time, which greatly reduces processing time and costs. At the same time, the connection sub-pads adopt a segmented design, which greatly reduces a width occupied by the signal lead in a lower bezel and is beneficial to realize a narrow bezel design of the touch display panel. Due to the full coverage design of the pad for the bonding region, it is advantageous to increase adhesion of the pad and improve its reliability.

As shown in FIG. 1B, the flexible printed circuit board 20 sequentially comprises a bending region 22 and a non-bending region 23 at one side of the first pad 21, and a portion of the bending region 22 of the flexible printed circuit board 20 is bent to make the non-bending region move to a backside of the display panel 10. The flexible printed circuit board 20 is provided with a plurality of hollow portions 220 spaced from each other in the bending region 22. The hollow portions 220 are arranged in a direction the same as a direction in which the first dummy sub-pads 211 are arranged, and each of the hollow portions 220 is positioned corresponding to each of the first dummy sub-pads 211. The hollow portions 220 are for dispersing stress applied to the first pad 21 when the flexible printed circuit board 20 is bent. A boundary of each of the hollow portions 220 is extended to a boundary of the first pad 21.

Certainly, one of the first dummy sub-pads 211 may be disposed corresponding to multiple spaced-apart hollow portions 220; the present invention is not limited in this regard.

The bending region 22 of the flexible printed circuit board 20 uses a hollow design, so stress in the bending region 22 is reduced when the flexible printed circuit board 20 is bent, thus preventing damage to the flexible printed circuit board 20 during bending and greatly enhancing reliability of the manufacturing process.

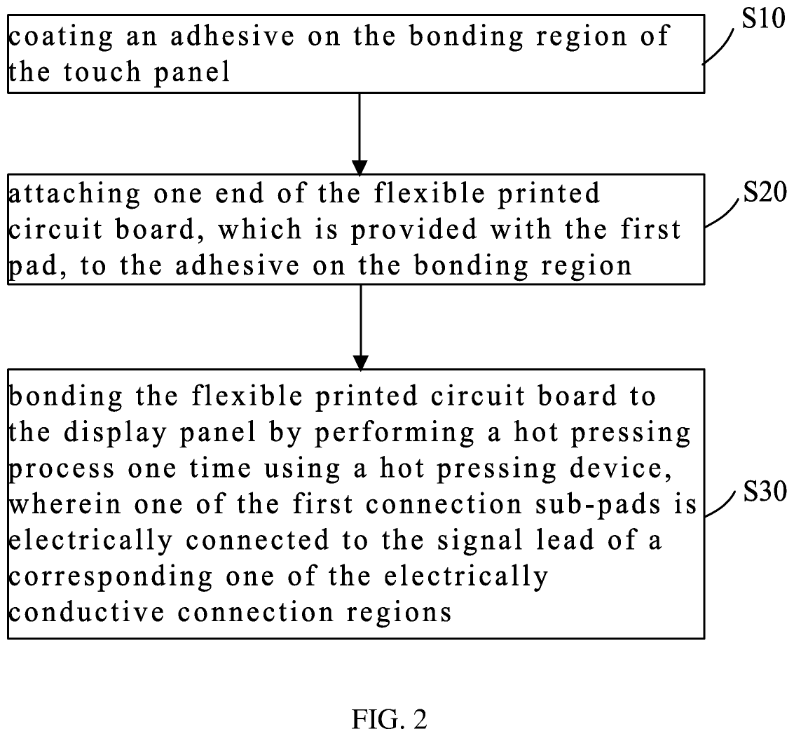

Please refer to FIG. 2. The present invention provides a bonding method of the above-mentioned touch display panel, the bonding method comprising following steps:

step S10: coating an adhesive on the bonding region of the display panel, wherein the adhesive covers the entire second pad, and the adhesive can be chosen from commonly used adhesives in manufacturing processes.

step S20: attaching one end of the flexible printed circuit board, which is provided with the first pad, to the adhesive on the bonding region, wherein because the first pad is disposed corresponding to the second pad, each first connection sub-pad is disposed corresponding to each second connection sub-pad, and each first dummy sub-pad is disposed corresponding to each second dummy sub-pad, so each first connection sub-pad and each second connection sub-pad can be precisely aligned simply by aligning the first pad with the second pad. This helps improve alignment accuracy and save processing time.

step S30: bonding the flexible printed circuit board to the display panel by performing a hot pressing process one time using a hot pressing device, wherein one of the first connection sub-pads is electrically connected to the signal lead of a corresponding one of the electrically conductive connection regions.

A first dummy sub-pad is filled between each two adjacent first connection sub-pads to form the first pad in an integral form, a second dummy sub-pad is filled between each two adjacent second connection sub-pads to form the second pad in an integral form, and therefore, the flexible printed circuit board can be bonded to the display panel at one time in the hot pressing process. This saves processing time and improves reliability.

The first dummy sub-pads are not electrically connected to the second dummy sub-pads.

In the touch display panel and the bonding method thereof provided by the present application, the dummy sub-pads having no electrical characteristics are distributed evenly to vacant spaces between the connection sub-pads which are arranged separately as multiple segments, the pads adopt a full coverage design which cover the bonding region, and thereby in the bonding process, expansion coefficients are stable, a bonding environment is stable, and the connection sub-pads positioned in multiple areas can be bonded at one time, which greatly reduces processing time and costs. At the same time, it is beneficial to realize a narrow bezel design of the touch display panel and is advantageous to increase adhesion of the pad and improve its reliability. In addition, the hollow portions are positioned in the bending region of the flexible printed circuit board, so stress in the bending region is reduced, thus greatly enhancing reliability of the manufacturing process.

It is to be understood that the above descriptions are merely the preferable embodiments of the present invention and are not intended to limit the scope of the present invention. Equivalent changes and modifications made in the spirit of the present invention are regarded as falling within the scope of the present invention.

What is claimed is:

1. A touch display panel, comprising:
a display panel, the display panel being provided with a bonding region disposed corresponding to a non-display region, the bonding region comprising at least two electrically conductive connection regions disposed separately and an electrically insulative connection region disposed between each adjacent two of the at least two electrically conductive connection regions;
a touch layer disposed on the display panel, the touch layer comprising a plurality of sensing electrodes and a plurality of signal leads electrically connected to the sensing electrodes respectively, another end of each signal lead being extended to a corresponding one of the electrically conductive connection regions; and
a flexible printed circuit board comprising a first pad disposed corresponding to the bonding region, the first pad being used to bond the bonding region and the display panel;
wherein the first pad comprises a plurality of first connection sub-pads each disposed corresponding to each electrically conductive connection region and a plurality of first dummy sub-pads each disposed corresponding to each electrically insulative connection region, the first connection sub-pads are used for being electrically connected to the signal leads, and the first connection sub-pads and the first dummy sub-pads are integrally formed.

2. The touch display panel according to claim 1, wherein a portion of at least one of the signal leads disposed in each electrically conductive connection region forms a second connection sub-pad, the display panel is provided with a second dummy sub-pad in each electrically insulative connection region, and the second dummy sub-pads and the second connection sub-pads form a second pad.

3. The touch display panel according to claim 2, wherein an adhesive layer is disposed between the first pad and the second pad, and the adhesive layer bonds the flexible printed circuit board to the display panel.

4. The touch display panel according to claim 2, wherein each first connection sub-pad is disposed corresponding to and electrically connected to each second connection sub-pad, and each first dummy sub-pad is disposed corresponding to each second dummy sub-pad and electrically insulated from the same.

5. The touch display panel according to claim 1, wherein the flexible printed circuit board sequentially comprises a bending region and a non-bending region at one side of the first pad, and a portion of the bending region of the flexible printed circuit board is bent to make the non-bending region move to a back-side of the display panel.

6. The touch display panel according to claim 5, wherein the flexible printed circuit board is provided with a plurality of hollow portions spaced from each other in the bending region.

7. The touch display panel according to claim 6, wherein the hollow portions are arranged in a direction the same as a direction in which the first dummy sub-pads are arranged, and each of the hollow portions is positioned corresponding to each of the first dummy sub-pads.

8. The touch display panel according to claim 7, wherein a boundary of each of the hollow portions is extended to a boundary of the first pad.

9. A bonding method of the touch display panel of claim 1, comprising following steps:
step S10: coating an adhesive on the bonding region of the display panel;
step S20: attaching one end of the flexible printed circuit board, which is provided with the first pad, to the adhesive on the bonding region;
step S30: bonding the flexible printed circuit board to the display panel by performing a hot pressing process one time using a hot pressing device, wherein one of the first connection sub-pads is electrically connected to the signal lead of a corresponding one of the electrically conductive connection regions.

10. A touch display panel, comprising:
a display panel, the display panel being provided with a bonding region disposed corresponding to a non-display region, the bonding region comprising at least two conductive connection regions disposed separately and an electrically insulative connection region disposed between each adjacent two of the electrically conductive connection regions;
a touch layer disposed on the display panel, the touch layer comprising a plurality of sensing electrodes and a plurality of signal leads electrically connected to the sensing electrodes respectively, another end of each signal lead being extended to a corresponding one of the electrically conductive connection regions; and
a flexible printed circuit board comprising a first pad disposed corresponding to the bonding region, the first pad being used for bonding the bonding region and the display panel;
wherein the first pad comprises a plurality of first connection sub-pads each disposed corresponding to each electrically conductive connection region and a plurality of first dummy sub-pads each disposed corresponding to each electrically insulative connection region, and the first connection sub-pads are used for being electrically connected to the signal leads.

11. The touch display panel according to claim 10, wherein a portion of at least one of the signal leads disposed in each electrically conductive connection region forms a second connection sub-pad, the display panel is provided with a second dummy sub-pad in each electrically insulative connection region, and the second dummy sub-pads and the second connection sub-pads form a second pad.

12. The touch display panel according to claim 11, wherein an adhesive layer is disposed between the first pad and the second pad, and the adhesive layer bonds the flexible printed circuit board to the display panel.

13. The touch display panel according to claim 11, wherein each first connection sub-pad is disposed corresponding to and electrically connected to each second connection sub-pad, and each first dummy sub-pad is disposed corresponding to each second dummy sub-pad and electrically insulated from the same.

14. The touch display panel according to claim 10, wherein the flexible printed circuit board sequentially comprises a bending region and a non-bending region at one side of the first pad, a portion of the bending region of the flexible printed circuit board is bent to make the non-bending region move to a back-side of the display panel.

15. The touch display panel according to claim 14, wherein the flexible printed circuit board is provided with a plurality of hollow portions spaced from each other in the bending region.

16. The touch display panel according to claim 15, wherein the hollow portions are arranged in a direction the same as a direction in which the first dummy sub-pads are arranged, and each of the hollow portions is positioned corresponding to each of the first dummy sub-pads.

17. The touch display panel according to claim 16, wherein a boundary of each of the hollow portions is extended to a boundary of the first pad.
